(19) United States
(12) Patent Application Publication
(10) Pub. No.: US 2007/0102355 A1
(43) Pub. Date: May 10, 2007

(54) Clarification process and decomposition arrangement

(76) Inventor: Joachim Steinbeck, Gorisried (DE)

Correspondence Address: JACOBSON HOLMAN PLLC, 400 SEVENTH STREET N.W., SUITE 600, WASHINGTON, DC, 20004, US

(21) Appl. No.: 11/588,379

(22) Filed: Oct. 27, 2006

(30) Foreign Application Priority Data
Oct. 27, 2005 (DE) 10 2005 051 754.4

(51) Int. Cl. C02F 3/02

(52) U.S. Cl. 210/620; 210/632; 210/209

(57) ABSTRACT

A clarification process for the substantially aerobic purification of sewage containing biological waste, in particular kitchen and household waste, is described as well as in particular a decomposition device for carrying out the process. The decomposition device has a clarification container which has a supply and a drain and an air feeding device which feeds air at the bottom of the clarification container.

### BACKGROUND OF THE INVENTION

The invention refers to a clarification process for the substantially aerobic sewage purification of sewage soiled by biological waste, in particular kitchen and household waste, in particular for carrying out the process in a decomposition device with a clarification container having a supply and a drain, and with an air feeding device which feeds air to the bottom of the clarification container.

DE 199 05 633 C1 describes a clarification process for purifying sewage substantially aerobically in a container as well as for carrying out the process in a decomposition device. The process comprises the steps of feeding sewage in batches at the top end of a nitrification zone, lowering the fed sewage batch in the nitrification zone by ventilation in batches at the bottom end of the nitrification zone in the inverse flow to the dropping sewage batch, short-term overflow caused by the ventilation of partly purified sewage at the top end of the nitrification zone in a non-ventilated drop zone or circulation zone. Besides also dropping of the partly clarified sewage in the non-ventilated drop zone, flowing up of sewage which is substantially purified from the drop zone and the nitrification zone in a mounting zone or post-clarifying zone, and draining the purified sewage at the top end of the mounting or post-clarifying zone are important.

DE 195 23 842 C2 describes a garbage disposal device, in particular for disposing of biologically decomposable kitchen and/or household garbage with a comminution device and a connection to a sewage system and with a filling container with a filling hole not serving as sewage drain for pouring in the waste which has to be disposed of, wherein the comminution device comprises a knife rotating within the filling container as pump rotor designed for pumping the comminuted garbage. For connection with the sewage system a garbage disposal line is provided for feeding the comminuted waste in a fork of a sewage line of a sink or a washbowl.

From DE 202 05 956 U1 a feeding station for an organic waste disposal device is known. It is preferably built in a kitchen sink and has a downstream comminution mill for the organic waste.

From the citation AT 403 374 B a compact small sewage treatment plant is known which is suited in particular for purifying the local household sewage and which has a pre-clarifying basin, an activated sludge basin provided with a ventilation and a post-clarifying basin, wherein one basin is connected to the other by passages for the liquid. In each of the pre-clarifying basin and, if necessary, the activated sludge basin at least one mixer is arranged, and a pumping line connects the post-clarifying basin with the pre-clarifying basin, the small sewage treatment plant being designed preferably in a cylindrical construction.

All small sewage treatment plants in the state of the art thus have a disadvantage in common that besides an unfavourable and not complete decomposition of the biological waste also a considerable obnoxious smell is noticed which makes the use in the household impossible. Through the discharge of solid material in the drain there is the risk that this drain, which typically has a diameter of 100 mm, gets filled with mud and, as a consequence, gets choked. The known small sewage treatment plants are used only outdoors because of their construction, however, here particular climate influences, for example frost and so on, have to be taken into consideration by constructive measurements.

### Short Abstract of the Invention

The present invention has the object to improve a clarification process or a decomposition device, respectively, of the type mentioned in the beginning.

According to the process this problem is solved by the following steps: supplying the soiled sewage to the clarification container below the water level of the clarification container, ventilating the clarification container from the bottom of the clarification container, and discharging the purified sewage. According to the device the problem is solved by designing the supply for soiled sewage in such a way that the sewage is fed to the clarification container below the water level of the clarification container.

By feeding the sewage containing biological waste and thus polluted or soiled below the water level to the clarification container a first effective stench trap is created. Thus the process in most of the cases arranged near a kitchen is not sensed as unpleasant as no stinking emissions are set free. The comfort for the user is thus increased. The clarification process can be carried out near a sink in the kitchen.

It is the result of the suggestion of the invention which is used in the process as well as in the decomposition device according to the invention that an effective and reliable stench trap is reached. This makes it possible that the process according to the invention or the decomposition device according to the invention, respectively can also be used indoors, for example in the kitchen, and so on. In this region, however, an expensive insulation to prevent the decomposition device from freezing in the winter is not necessary, so that surprisingly the invention is considerably more accepted as an effective sewage purification does without a large effort in the construction (for example insulating of an external sewage box with a corresponding sewage treatment plant). Besides a decomposition process of the garbage is more effective when the room temperature remains almost the same than a decomposition process where the temperature varies partially considerably.

The invention makes sure that no undesired discharge of solid material into the channel occurs so that the risk of filling with mud or choking of the house connection is prevented reliably which avoids otherwise occurring expensive maintenance and repair works.

Advantageously the soiled sewage is passed over via a supply with a connection in the bottom region of the clarification container. Thus it is guaranteed that the stench-sealing is efficient, that means that it works effectively already when the clarification container is filled a bit, and the sewage can always run through the biological decomposition process from the bottom, and thus, if necessary, a maximal long decomposition path is provided in a multichamber system.

Preferably it is provided to filter sewage which flows above the water level in the clarification container, in particularly covering a large surface.

Thus it is guaranteed that only purified sewage is drained. A filter device arranged on a large surface is an advantage as it does choke a drain less or hardly, and thus a long lasting operation of the clarification process or the decomposition device, respectively, is guaranteed. The filter device is therefore preferably arranged at the water surface at least in the chamber with the drain.

A large surface in the sense of the invention here a filter is seen which covers much more than 25%, in a preferred modification more than 50%, of the cross section surface of the container. By means of an accordingly large surface design the risk of the filter being soiled too fast is counteracted, and the necessary inspection works are reduced to a minimum.

The filter device, which is arranged at the height of the water level in the clarification container, makes sure that only purified sewage gets to the drain, and larger solid materials which are not (yet) decomposed by means of the clarification treatment device in the clarification container, remain as long as they are either completely decomposed or disintegrated, or until an inspection, that means emptying the clarification container, is carried out. The filter device is made of synthetic material with wide pores, preferably a PVC sponge.

Because of filtering the biologically decomposable water in a clarification container the drain pipes are protected from deposition of solid material so that the result is a longer life of the draining as well as a relief of the local sewage treatment plant and waste dump. Besides, a household which does not depend on the local sewage treatment plants can be realised better. The process according to the invention achieves also that, because of the supply of the sewage in the bottom or at the bottom of the clarification container, a stench-trap forms in the way of the siphon principle which acts on its own. It is not necessary to create additional exhaust measurements at the entrance region, the sewage and, if necessary, at the connection to the supply to the house region in order to avoid the nasty smells known from the state of the art. They are completely avoided here automatically by arranging the supply in the bottom region and providing the supply otherwise above the water level as, by means of that, a siphon forms and the water column acts as the stench trap in the supply. Such a solution is not known from the state of the art and is not suggested by it, either. The invention therefore adds in an excellent way to the solution of the problem that a discharge of solid materials in a drain is reduced as economically and permanently as possible the elimination of the disadvantages of the obnoxious smell known from the state of the art.

Preferably the waste is comminuted, in particular to a grain size of 3-10 mm, preferably 4-5 mm, by a comminution device before it is supplied to the clarification container. This makes sure that sufficiently small solid materials are supplied to the clarification container in the sewage. The waste should have a surface as large as possible so that it can be decomposed in the clarification container, this is the reason why it is comminuted as far as possible in the comminution device. A comminution device, which may be a grinding gear or a mill, is known from the state of the art and described for example in DE 195 23 842 C2 or DE 202 05 956 U1. The comminution device can either have a rotating knife or a shredder device or a grinding gear or any other suitable mechanism in order to provide a desired grain size (about 4 to 5 mm) of the biologically decomposable material.

The comminution device can also be switched on by means of a switch which is operated manually.

Conveniently the entire clarification container is ventilated in order to reduce the development of rotting and to accelerate the decomposition process, if there are several chambers, also these chambers of the clarification container are ventilated. In order to ventilate the entire clarification container completely the ventilation is done already from the bottom level or at bottom level, respectively. Thus the entire clarification container is provided with small air bubbles.

Preferably the ventilation of the clarification container is carried out continuously or permanently, respectively, with an air feeding device. That means the air feeding device is arranged in the entire clarification container or in all clarification chambers, respectively. Preferably the air feeding device has supply lines below the bottom of the clarification container in order to feed air to the clarification container at the level of the bottom, and pumped air runs out of air feeding holes arranged in the bottom of the clarification container. The air feeding device has a small pump known from the state of the art the power and size of which are dimensioned depending on the volume of the clarification container, and which has an energy consume as small as possible. The power range of the electrically working pump, which can work permanently, is between 20 and 100 W, preferably in the region of 30 to 50 W, in particular preferred in the region between 35 and 45 W. As the clarification container is ventilated permanently a continuous nitrification is guaranteed.

Preferably the comminution device has a control circuit for switching on and off the drive motor of the comminution device. The comminution device is only switched on because of the control circuit when biological waste is added. For that purpose a sensor or a switch could be provided as an actuator. For example the actuator could be connected with the tap so that, when the tap is open, at the same time the comminution device is switched on, and, possibly with a certain delay, is switched of again, also optical or electronic sensors which are common with automatic sinks can be used as actuators.

The clarification container is made of opaque material so that the clarification process, the decomposition of the solid parts in the clarification container, can work without trouble. The clarification container has, in a preferred modification, two dividing walls which divide the clarification container in three chambers which have to be flown through by the sewage.

One dividing wall extends from the bottom of the clarification container and has to be flown over by the sewage. The other dividing wall extends from the ceiling region to the bottom of the clarification container, the dividing wall being open near the bottom region so that the sewage must flow through this bottom region of the clarification container in order to get to the drain. The sewage in the clarification container is passed over, when it flows over the first dividing wall, from a pre-clarifying chamber in a main clarifying chamber. In order to discharge developing gases of the first and second chamber, that means of the pre-clarifying chamber and part of the main clarifying chamber, an exhaust channel to the drain is provided. The filter device is in this modification in the last, third clarifying chamber which has to be flown through by the sewage on the height of the water level.

Because of the microorganism contained and developing in the waste and in the sewage the biological waste is decomposed so long in the clarification container until the decomposed waste can pass the filter with the wide pores.

In order to improve or accelerate, respectively, the decomposition process in the clarifying container enzymes in the clarifying container can be added through an opening in the ceiling region of the clarifying container. This addition can, of course, be automated through a dosing device with a control. The clarification container can have at least one inspection opening with a corresponding lid and a seal in order to clean the clarification container of solid materials in regular intervals or depending on the degree of soiling, or to exchange the filter device.

Preferably the clarification container has a volume of 15 to 50 l, preferably between 20 and 25 l, depending on the size of the household, that means the persons living in the household. On the bottom of the clarification container a flushing pump may be arranged in a flushing channel which leads to the drain of the decomposition device. The flushing channel can be opened by a bolt in order to flush the clarification container in regular intervals in a cleaning process. The intervals of flushing may also be controlled by electronic circuits by means of sensors.

Preferably the decomposition device has a waste opening of such a size before the comminution device so that even common organic waste can be received. Thus the share of organic waste in a garbage can is reduced considerably so that the problems which come with an organic garbage can and the subsequent utilisation at the waste dump are avoided.

Conveniently the supply is designed with a first connection above the water level and a second connection in the bottom region of the clarification container in order to supply sewage to the clarification container.

Preferably a top part of the supply and the drain are arranged at the same level. However, the supply is guided to the bottom of the clarification container. The clarification container is arranged in a lower position. By means of that the siphon principle is created by the water column in the supply to seal the smells of the clarification container.

In an alternative embodiment a smaller siphon trap is inserted before or in the supply, respectively, in order to secure an even more efficient smell sealing.

The decomposition device may be arranged in the drain path of the sewage, in particular of kitchen sinks, in any place in the building so that the sewage is discharged into the sewerage after that. Preferably the decomposition device is dimensioned such that it can be stored substantially below a sink and is arranged, in particular, after or instead a siphon trap of a kitchen sink, and additionally preferably the drain of the sink serves as waste opening.

Thus an extremely effective decomposition device for household and kitchen waste with small effort for construction and components is created which makes the disposal of such waste easier and spares the local disposal institutions as well as the drain channels. Retrofitting is possible without any problems.

In another preferred modification of the invention it is provided that the decomposition device has a smell-tight housing, and the housing has a separate exhaust line, or the exhaust is done via the drain. This achieves an optimal protection from obnoxious smell, exhaust is carried out here, if necessary, either via the drain as in the other regions of sewage or via a separate exhaust line which can leave the building at a suited point. In an alternative embodiment a pump may be arranged in the supply in order to feed the sewage to the clarification container.

It is clear that the characteristics mentioned before and which have to be discussed the following can be used not only in the respective cited combination but also in other combinations.

In this connection it has to be pointed out in particular that all characteristics and features described in view of the decomposition device, but also processes, can be transferred accordingly also with respect to the formulation of the process according to the invention and can be used in the sense of the invention and are also seen as disclosed. The same goes vice versa, that means that constructive, that means device characteristics only mentioned in view of the process may also be taken into consideration and claimed in the frame of the device claims of the decomposition device, and also count as part of the invention and disclosure.

### BRIEF DESCRIPTION OF THE DIFFERENT VIEWS AND Drawings

The invention is described in detail in the following with two embodiments with reference to two corresponding drawings. In the figures:

FIG. 1 a cross section of a decomposition device according to the invention,

FIG. 2 a cross section of a decomposition device with three chambers according to the invention,

FIG. 3 a cross section of a decomposition device according to FIG. 2 with a separate waste opening.

### DETAILED DESCRIPTION OF THE PREFERRED EMBODIMENT

FIG. 1 shows schematically a decomposition device 1 with a clarification container 2. The clarification container 2 has a supply 3 and a drain 4. The supply 3 has a first connection 27 above the water level 32 of the clarification container 2, and leads via a second connection 23 to the bottom 25 of the clarification container 2. Thus a siphon principle is created which is known in households with sinks in order to generate a smell seal. The known siphon is substituted by the decomposition device 1 with siphon function. Thus the comfort for the user is increased, the decomposition device 1 can be installed near the sink in a kitchen without emission of smells. The clarification container 2 has, at the height of the water level 32, a plane filter device 6 of preferably plane material with wide pores. The material may be PVC and is preferably a sponge material known in the surroundings of the kitchen. The large surface filter material has the advantage that the drain 4 does not get choked, and only purified sewage 40 can pass through. The filter device 6 itself does not get choked so fast, either, and does not need additional expensive cleaning devices. A reliable long term operation is guaranteed.

At the bottom of the clarification container 2 an air feeding device 5 is arranged. The air feeding device 5 comprises a pump, for example an aquarium pump which works permanently and consumes as little energy as possible.

Air feeding lines of the air feeding device 5 are arranged below the bottom 25 of the clarification container 2, air feeding openings 52 being distributed in the entire bottom 25 of the clarification container 2, so that the entire clarification container 2 is treated with air, and the clarification container is used efficiently so that no blind spots or spaces not flown through by air may arise in the clarification container.

A comminution device 7 designed as mill is arranged at the supply 3 and comminutes the biological kitchen and household waste coming from a waste opening 8 to a grain size of 4-5 mm. The comminution device is known substantially in the state of the art. It is, for example, described in DE 202 05 956 U1 and is on sale among others under the name “Sinkmaster” by SBM Maschinen GmbH.

The waste opening 8 substitutes the drain opening of a common sink 9. The waste opening 8 is preferably designed larger than a common sink drain opening to be able to receive larger biological waste. Thus a simple waste disposal device is created for disposing biologically decomposable kitchen and household waste which disposes of the waste substantially directly at the place where the waste occurs. The biologically decomposable material is wetted already in the sink with a minimal use of components, comminuted in the mill and together with the sewage 30 flushed in the clarification container 2.

The clarification process works in the following way: In the sink the biologically decomposable leftovers of food and meals are put in the waste opening 8. Subsequently they are comminuted in the comminution device 7. By means of the dish water these comminuted particles are passed over in the clarification container 2 via the supply 3. In the clarification container 2 the biological solid parts are decomposed by micoorganisms while air is added. The nitrification takes place basically without the addition of enzymes. However, enzymes may improve and accelerate the clarification process. Microorganisms are present in the old sewage 20 permanently in the clarification chamber(s) of the clarification container 2 which could decompose fresh garbage.

By means of the filter 6 only purified water is drained into the drain 4. Because of the nitrification substantially all solid parts are decomposed so that on the bottom 25 of the clarification container 2 even after longer periods of time hardly any solid materials are deposited. Tests showed that in a two-persons household in a period of half a year about 250 to 300 g solid material is deposited on the bottom of the clarification container 2.

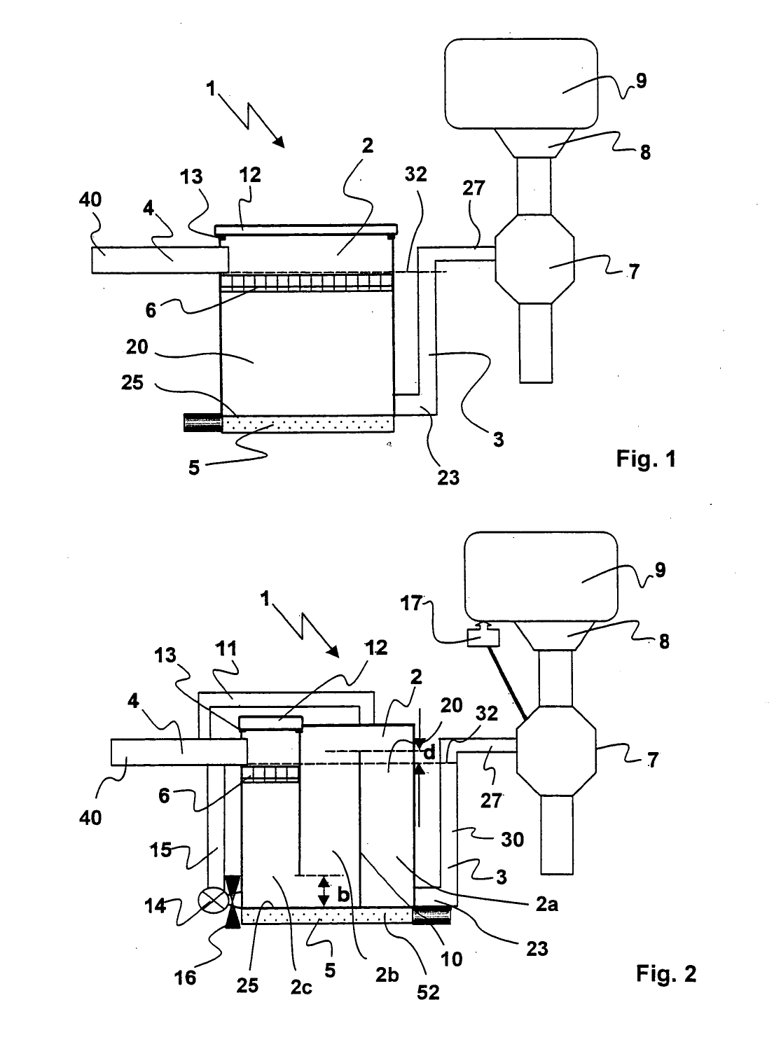

FIG. 2 shows another particular embodiment of the decomposition device 1 with a clarification container 2 which has three chambers 2a, 2b, 2c caused by dividing walls. The individual chambers 2a, 2b, 2c have to be run through by the sewage 20 because of the arrangement of the dividing walls 10—that means because of a restricted guidance. The dividing wall 10 of the first chamber 2a extends coming from the bottom 25 above the water level of the clarification container 2 which is defined by the height of the drain 4 with a distance d. The sewage 20 has to flow over the sill with the distance d from the first dividing wall 10 in order to get in the second chamber 2b of the clarification container 2. The second dividing wall extends from the ceiling region of the clarification container 2 in the direction of the bottom region of the clarification container 2 with an open distance D to the bottom so that the sewage 20 has to flow through this bottom region in order to get into the third chamber 2c.

Floating in the height of the water level 32 of the third chamber 2c there is the filter device 6 which only lets pass through purified sewage 40. The air feeding device 5 feeds air from the bottom 25 to all three chambers 2a, 2b, 2c. Because of the aerobic decomposition process in all three chambers the sewage 20 is purified more efficient and faster, developing of rotting and thus developing of stench is prevented. In order to use the chambers 2a, 2b, 2c optimally for the decomposition the air generated by air feeding device 5 runs directly from the bottom 25 of the clarification container 2 out of air feeding openings 15.

In order to discharge developing gases of the first and second chambers 2a and 2b in the clarification container 2 an exhaust channel 11 is provided to the drain 4 of the clarification container 2. The clarification container 2 has an inspection opening 12 which is sealed with a seal 13 so that the filter 6 can be exchanged.

In addition to that a flushing pump 14 with a flushing channel 15 is provided which leads from the bottom region of the clarification container 2 to the drain 4. The flushing channel 15 is opened and closed by a stop 16 arranged before the pump 14. By means of the flushing channel 15 the clarification container 2 can be cleaned, if necessary. Of course, also a control (not shown) may be provided which opens the stop 16 for cleaning the clarification container 2 and switches on the flushing pump 14, when a measurable limiting value is exceeded because of increasing depositing of solid materials. The limiting value of the deposited solid materials can be defined by means of known sensors. The control then switches of, after a pre-determined time or procedure, the flushing pump 14 and closes the flushing channel with the stop 16. With such an automatic a selection of a pure water supply which can be hooked up is provided.

The comminution device 7 can also be switched on and of because of a control circuit 17. In the state of the art a number of modifications for such a control circuit 17 is known. Switching on and of the comminution device can be synchronised by means of a control circuit 17 with the tap of a sink, the operation of switching of being conveniently delayed. An optical sensor as it is known from automatic wash bowl devices may also serve as actuator for the control of the comminution device.

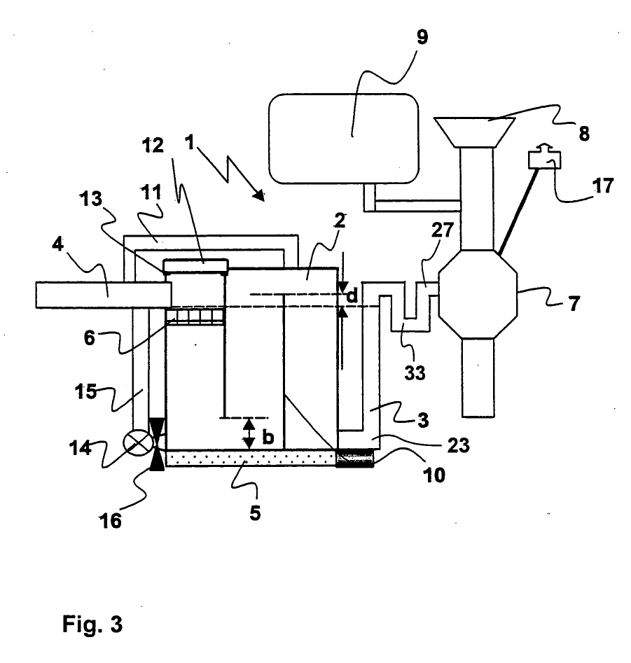

FIG. 3 shows a decomposition device 1 according to FIG. 2 with the difference that the waste opening 8 is not arranged below the sink 9 but is located separately at the side of a sink.

If necessary also from the sink 9 sewage can be passed over to the comminution device 7. However, the sink and the waste opening 8 are designed separately. The control circuit 17 is operated manually in order to switch on the comminution device 7, and to switch it of preferably time controlled. The control circuit 17 may either comprise a circuit closer/breaker or a key button.

For an even more efficient stench seal in the drain 3 another small siphon trap 33 is arranged which secures that even weak developing rotting smells cannot get in the waste opening 8.

Thus a handy decomposition device with optimised consumption of energy and resources is created.

Although the invention has been described by exact examples which are illustrated in the most extensive detail, it is pointed out that this serves only for illustration, and that the invention is not necessarily limited to it because alternative embodiments and methods become. clear for experts in view of the disclosure. Accordingly changes can be considered which can be made without departing from the contents of the described invention.

1. Clarification process with a substantially aerobic sewage purifying process of sewage (30) soiled with biological waste, comprising the steps of supplying the waste in the sewage to a clarification container (2), ventilating the clarification container (2) from the bottom of the clarification container (2), and discharging the purified sewage (40), characterised in that for trapping the stench the soiled sewage (30) is supplied to the clarification container (2) below the water level (32) of the clarification container (2).

2. Clarification process according to claim 1, characterised in that the soiled sewage (30) is supplied via a supply (3) with a connection (23) to the bottom region of the clarification container.

3. Clarification process according to claim 1, characterised in that the sewage (40) flowing above the water level (32) in the clarification container (2), is filtered, in particular covering a large surface.

4. Clarification process according to claim 1, characterised in that the waste is comminuted before it is supplied to the clarification container (2), in particular to a grain size of 3-10 mm, preferably 4-5 mm.

5. Clarification process according to claim 1, characterised in that the entire clarification container (2) is ventilated, if necessary, by several chambers (2a, 2b, 2c) of the clarification box (2).

6. Clarification process according to claim 1, characterised in that the ventilation is carried out on the bottom level of the clarification container (2).

7. Clarification process according to claim 1, characterised in that the ventilation of the clarification container (2) is continuous.

8. Clarification process according to claim 1, characterised in that waste water (.20) in the clarification container (2) is passed over from a pre-clarifying chamber (2a) to a main clarifying chamber (2b).

9. Clarification process according to claim 1, characterised in that waste water (20) in the clarification container (2) is passed over from a pre-clarifying chamber (2a) in a main clarifying chamber (2b), and the developing gases of the pre-clarifying chamber (2a) are passed over to the drain (4).

10. Clarification process according to claim 1, characterized in that enzymes are added to the clarification container (2).

11. Decomposition device (1), in particular for biologically decomposable kitchen and household waste, with a clarification container (2) having a supply (3) and a drain (4), and with an air feeding device (5) which feeds air at the bottom of the clarification container (2), in particular for carrying out the process according to claim 1, characterized in that the supply (3) for soiled sewage (30) is designed in such a way that the sewage (30) is fed below the water level (32) of the clarification container (2) in the clarification container (2).

12. Decomposition device according to claim 11, characterised in that the supply (3) is designed with a first connection (27) above the water level (32) and with a second connection (23) in the bottom region of the clarification container (2) in order to feed soiled sewage (30) to the clarification container (2).

13. Decomposition device according to claim 11, characterised in that at the surface (32) of the water of the clarification container (2) at least in the chamber (2c) of the clarification container (2) with the drain (4) a filter device (6), in particular with a large surface, is arranged.

14. Decomposition device according to claim 11, characterised in that the filter device (6) is made from material with wide pores, preferably from synthetic material, in particular PVC.

15. Decomposition device according to claim 11, characterised in that a comminution device (7), preferably designed as comminution mill, is arranged in the sewage circuit before the supply (3) of the clarification container (2).

16. Decomposition device according to claim 11, characterised in that the comminution device (7) has a control circuit (17) for switching on and off the comminution device (7).

17. Decomposition device according to claim 11, characterised in that the clarification container (2) is made of opaque material.

18. Decomposition device according to claim 11, characterised in that the clarification container (2) has two dividing walls (14) which divide the clarification container (2) in three chambers (2a, 2b, 2c) which have to be flown through by the sewage.

19. Decomposition device according to claim 11, characterised in that the clarification container (2) has two dividing walls (14) dividing the clarification container (2) in three chambers (2a, 2b, 2c) which have to be flown through by sewage, and the filter device (6) is arranged in the last chamber (2c).

20. Decomposition device according to claim 11, characterised in that the clarification container (2) has at least one inspection opening with a corresponding lid and seal, in particular for the filter device (6).

21. Decomposition device according to claim 11, characterised in that the clarification container (2) has at least two dividing walls (14) which divide the clarification container (2) in three chambers which have to be flown through by sewage, and a ventilation channel (11) is provided for a first and a second clarifying chamber (2a, 2b).

22. Decomposition device according to claim 11, characterised in that the clarification container (2) has a volume of about 15 to 50 l, preferably 20 to 25 l.

23. Decomposition device according to claim 11, characterised in that the air feeding device (5) is arranged in the clarification container (2) altogether or in all clarifying chambers, respectively.

24. Decomposition device according to claim 11, characterised in that the air feeding device (5) has supply lines (52) below the bottom (25) of the clarification container (2) in order to feed air to the clarification container (2) at bottom level.

25. Decomposition device according to claim 11, characterized in that the air feeding device (5) has a permanently working pump with a power in the region of 20 to 100 Watts, preferably in the region of 30 to 50 Watts, in particular preferred 35 to 45 Watts.

26. Decomposition device according to claim 11, characterised in that before or in the supply (3) a siphon trap (33) is inserted.

27. Decomposition device according to claim 11, characterized in that a comminution device (7), designed preferably as comminution mill, is arranged in the sewage circuit before the supply (3) of the clarification container (2), and a waste opening (8) is provided before the comminution device (7) in such a size that common biological waste can be received.

28. Decomposition device according to claim 11, characterised in that a part of the supply and the drain (4) are arranged on the same level, and the clarification container (2) is arranged lower.

29. Decomposition device according to claim 11, characterized in that the decomposition device (1) is arranged substantially below a sink (9), in particular behind or instead a siphon trap, a waste opening (8) is provided in such a size that common biological waste can be received, and preferably the drain of the sink serves as waste opening (8).

30. Decomposition device according to claim 11, characterised in that the decomposition device has a smell-tight housing, and the housing has a separate exhaust line, or the exhaust is carried out through the drain channel (4).
